(19) United States
(12) Patent Application Publication
(10) Pub. No.: US 2025/0261664 A1
(43) Pub. Date: Aug. 21, 2025

(54) TEXTURED FAVA BEAN PROTEIN PRODUCT

(71) Applicant: VERSO FOOD OY, Raisio (FI)

(72) Inventor: Elli LAUKKALA, Raisio (FI)

(73) Assignee: VERSO FOOD OY, Raisio (FI)

(21) Appl. No.: 18/857,864

(22) PCT Filed: Apr. 21, 2023
(86) PCT No.: PCT/FI2023/050221

§ 371 Date: Oct. 18, 2024

(30) Foreign Application Priority Data
Apr. 22, 2022 (FI) 20227055

(51) Int. Cl. A23J 3/22; A23J 3/14; A23J 3/26; A23L 11/00; A23L 33/125; A23L 33/21

(52) U.S. Cl. CPC A23J 3/227; A23J 3/14; A23J 3/26; A23L 11/05; A23L 33/125; A23L 33/21

(57) ABSTRACT

The invention relates to a textured fava bean protein product and to a method of manufacturing the same.

### FIELD OF THE INVENTION

The invention relates to a textured fava bean protein product and to a method of manufacturing the same.

### BACKGROUND OF THE INVENTION

Soybean is the main protein source in the global food supply. It is not only rich in essential amino acids, but also an inexpensive and commonly available protein ingredient for different food applications. Besides, soy protein has excellent physicochemical and technological properties which enable production of textured soy protein having fibrous, spongy matrix, similar in texture to meat. Indeed, textured soy protein is a well-known and a versatile ingredient for substituting meat protein in vegan or vegetarian diches and diets, typically available as dry granules or chunks with long storage life. However, soy is one of the most common allergens. Soy is problematic in some markets also due to concerns relating to genetically modified soy varieties. A further concern relates to high concentrations of plant estrogens in soy ingredients. There is thus a need to find a replacement for soy as a protein source in vegan and vegetarian dishes, as well as in meat substitute products.

Fava beans are high in protein and other important nutrients, making them an attractive option to replace soy. Indeed, some textured fava bean protein products, whose protein content is 100% fava bean-derived, are commercially available. However, such products lack sufficient structural integrity after rehydration and cooking resistance. In addition to protein, fava bean is also rich in starch, making it a challenging raw material for protein texturization processes, such as dry and/or wet extrusion.

Thus, there is an unmet need for textured non-soy based protein products such as fava bean protein products that are suitable for use in a variety of vegan and vegetarian dishes owing to improved structural integrity.

### BRIEF DESCRIPTION OF THE INVENTION

The invention relates to a textured fava bean protein product according to any one of claims 1 to 12, as well as to a method of manufacturing the same by low-moisture protein texturization extrusion according to any one of claims 13 to 16. The invention also relates to a textured fava bean protein product obtainable by said method as defined in independent claim 17, as well as to a food product according to independent claim 18.

Other objects, aspects and embodiments of the present invention will become apparent from the following figures, detailed description and examples.

### FIGURES

The accompanying figures, which are included to provide a further understanding of the invention and constitute a part of this specification, illustrate embodiments of the invention and together with the description help to explain the principles of the invention.

FIG. 1 shows the appearance of extruded ribbons prepared in accordance with Example 1. The comparative ribbons on the left were prepared without edible plant-derived fibres in the recipe, whereas the ribbons on the right included edible plant-derived fibres in their recipe in accordance with the present invention. Importantly, air cavities and as well as glossy membraneous structures were lost when the recipe contained plant-derived edible fibres.

FIG. 2 shows the appearance of the commercially available textured soy protein product (on the left) and the present TFP product (on the right) used in Example 2.

### DETAILED DESCRIPTION OF THE INVENTION

An object of the invention was to develop a soy-free textured fava bean protein (TFP) product having meat-like bite with visible fibres. A further object was to gain functional and structural characteristics resembling those of commercially available textured vegetable protein (TVP) products made from soy.

Before the invention is further described, it is to be understood that this disclosure is not strictly limited to the particular embodiments described herein, as such can of course vary. It is also to be understood that the terminology used herein is for the purpose of describing particular embodiments only, and is not intended to be limiting, since the scope of the present invention will be limited only by the appended claims.

It is also to be noted that, unless defined otherwise, all technical and scientific terms used herein have the same meaning as commonly understood by one of ordinary skill in the art to which this invention belongs.

It is further to be noted that certain features of the disclosure, which are, for clarity, described in the context of separate embodiments, can also be provided in combination in a single embodiment. Conversely, various features of the disclosure, which are, for brevity, described in the context of a single embodiment, can also be provided separately or in any suitable sub-combination. Moreover, all combinations of the embodiments are specifically embraced by the present disclosure and are disclosed herein just as if each and every combination was individually and explicitly disclosed. In addition, all sub-combinations are also specifically embraced by the present disclosure and are disclosed herein just as if each and every such sub-combination was individually and explicitly disclosed herein.

It is further noted that the claims can be drafted to exclude any optional element. As such, this statement is intended to serve as antecedent basis for use of such exclusive terminology as “solely,” “only” and the like in connection with the recitation of claim elements or use of a “negative” limitation.

All ranges and parameters, including but not limited to percentages and ratios disclosed herein, are understood to encompass any and all sub-ranges subsumed therein, and every number between the endpoints. For example, a stated range of “1 to 10” should be considered to include any and all sub-ranges beginning with a minimum value of 1 or more and ending with a maximum value of 10 or less, including all integers, whole or fractions, contained within the range. Thus, the stated range of “1 to 10” should be construed as supporting, for example, a range of from 1 to 8, from 3 to 6.6, from 1 to 9, from 3.6 to 5, from 3.5 to 9.9, and so forth.

As used herein, the term “about” refers to a range of values±10% of a specified value. For example, the phrase “about 80 wt %” includes ±10% of 80 wt %, or from 72 wt % to 88 wt %. The term “about” is interchangeable with the term “around”.

The percentages used herein are weight percentages (abbreviated wt %) on dry matter basis, unless otherwise indicated.

As used herein and in the appended claims, the singular forms “a”, “an”, and “the” mean one or more. Thus, a singular noun, unless otherwise specified, carries also the meaning of the corresponding plural noun, and vice versa. As such, the terms “a”, “an”, “one or more” and “at least one” can be used interchangeably.

As used herein, the term “and/or” in a phase such as “X and/or Y” shall be understood to mean either “X and Y” or “X or Y” and shall be taken to provide explicit support for both meanings or for either meaning.

As used herein, the terms “comprising”, “including”, “containing” and “having” are interchangeable.

As used herein, the term “textured plant protein product” refers broadly to a food product that has been transformed from an edible flour-type protein material into one which has a meat-like texture with protein fibres that are substantially aligned in a manner similar to animal meat.

The present invention relates to a textured plant protein product containing fava bean protein, therefore denoted herein as a textured fava bean protein (TFP) product.

The TFP product of the invention is rich in plant protein, and contains no animal-derived ingredients. To be more precise, the total plant protein content of the product ranges from 56 wt % to 80 wt % on dry basis. The TFP product may thus comprise, for example, from 58, 59, 60, 61, 62, 63 or 64 wt % up to 66, 68, 70, 72, 74, 76 or 78 wt % of plant protein.

To achieved such a high total protein content, the main components of the TFP product of the invention are plant protein components. Indeed, plant protein components of this disclosure deliver 90 to 99 wt % of the dry matter content of the product. The TFP product may thus comprise from 90, 91, 92, 93, 94, 95, 96, 97 or 98 wt % up to 91, 92, 93, 94, 95, 96, 97, 98 or 99 wt % of plant protein components on dry basis.

Of the plant protein components in the TFP product, an amount of 45-85 wt % is derived from fava bean. In other words, from 45, 50, 55, 60, 65, 70, 75 or 80 wt % up to 50, 55, 60, 65, 70, 75, 80 or 85 wt % of the protein components are fava bean-derived. In some embodiments, the fava bean-derived protein component is provided into the product in the form of a fava bean flour, a fava bean protein concentrate or a fava bean protein isolate or mixtures of these. Preferably, the fava bean-derived protein component is a fava bean protein concentrate. Especially for embodiments that aim at including a high proportion of fava bean-derived protein components, an amount of 65-85 wt % of fava bean-derived components, preferably fava bean concentrate, is particularly preferred.

As used herein, the term “fava bean” refers to the species Vicia faba of the Fabaceae or Leguminosae family, commonly known as the legume family, and in particular to the pulses, i.e. edible seeds, thereof. Fava beans are also known as faba beans, broad beans, field beans and bell beans.

As used herein, the term “fava bean flour” refers to a powder obtained by grinding the fava bean pulses. The protein content of a typical fava bean flour is around 30 wt %, such as 26-34 wt %, on dry basis.

As used herein, the term “protein concentrate” refers to powdered protein material obtained from a plant source by at least partial removal of soluble carbohydrate and other constituents thereby increasing the relative protein content in the powder. Typically, this can be achieved by air classification. Protein concentrates commonly contain from about 50 wt % to less than about 80 wt % protein, most commonly from about 60 wt % to about 70 wt % protein. In other words, the protein content of a typical protein concentrate may vary, for example, from 50, 55, 60, 65, 70 or 75 wt % up to 55, 60, 65, 70, 75 or 80 wt %. Accordingly, the term “fava bean protein concentrate” refers to a protein concentrate derived from the seeds of fava beans.

As used herein, the term “protein isolate” refers to powdered protein material that has typically undergone additional processing as compared to protein concentrates such that it has a protein content of at least 80 wt %, most commonly between about 80 wt % and about 90 wt %. In other words, the protein content of a typical protein isolate may vary, for example, from 80, 82, 84, 86 or 88 wt % up to 82, 84, 86, 88 or 90 wt %. Accordingly, the term “fava bean protein isolate” refers to a protein isolate derived from the seeds of fava beans.

In accordance with the above, the term “plant protein component” refers collectively to any plant-derived protein-containing flours, protein concentrates, protein isolates or mixtures thereof used in the TFP product.

Using fava bean protein, for example in the form of a protein concentrate, as the sole protein component in the TFP product of the invention resulted in too weak a structure. Therefore, the product comprises at least one further plant protein component that is derived from a plant source other than fava bean. Such non-fava bean protein components deliver together 15-55 wt % of the total plant protein components in the TFP product. In other words, of the plant protein components in the TFP product from 15, 20, 25, 30, 35, 40, 45 or 50 wt % up to 20, 25, 30, 35, 40, 45, 50 or 55 wt %, for example, come from at least one non-fava bean protein component. Such a protein component is preferably provided in the form of a protein concentrate, a protein isolate or any mixture thereof.

In some preferred embodiments, the at least one plant protein component derived from a source other than fava bean is provided into the product in the form of one or more protein isolates. Isolates not only increase the protein content of the final product, as may be desired from a nutritional perspective, but also reduce the starch content of the final product as compared to final products in which the non-fava bean protein component is provided in the form of one or more protein concentrates. This will help in reducing, but not completely prevent, expansion (i.e., puffing or formation or air cavities) of the TFP product upon its manufacture by protein texturization extrusion. As a result of puffing, the extrudate will gain crispier texture, resembling that of breakfast cereals. Puffing is to be avoided since it reduces the meat-like texture and bite of the extruded product.

Suitable sources for the at least one further plant protein component include nuts, cereals, seeds, tubers and legumes other than fava beans or soybeans. Non-limiting examples of suitable legumes include chickpeas, green peas, yellow peas, lentils, peanuts, trefoil, pinto beans, haricot beans, mung beans, navy beans, red beans, black beans, dark and light red kidney beans, green baby lima beans, pink beans, myasi beans, black eyed beans, cranberry beans, white beans, rice beans, butter beans and the like. Non-limiting examples of nut protein sources include pecans, hazelnuts, walnuts, Brazil nuts, cashews and almonds, whereas cereals proteins may be derived from sources other than wheat including, for example, from rice, oats, amaranth, barley, buckwheat, fonio, millet, rye, sorghum, triticale, or quinoa. Non-limiting examples of seed protein sources include cottonseeds, flaxseeds, sunflower seeds and rapeseed, whereas tuber protein may be derived, for example, from potatoes. Each possibility represents a separate embodiment of the invention. In accordance with the above, the product may be denoted as e.g. soy-free and/or gluten-free, especially wheat gluten-free. In some embodiments, the TFP product may also be devoid of any oat and/or rapeseed material, especially protein. In some preferred embodiments, the TFP product of the invention comprises 15-55 wt % of pea protein, preferably pea protein isolate, calculated from the total amount of plant protein components in the product.

In accordance with the above, protein components of the TFP product of the invention comprise 45-85 wt % of a fava bean protein component, preferably a fava bean protein concentrate, and 15-55 wt % of a plant protein component derived from a source other than fava bean, preferably a plant protein isolate, more preferably a pea protein isolate.

Thus, in some embodiments, fava bean protein components deliver 45 wt %, while plant protein components derived from a plant source other than fava bean deliver 55 wt % of the protein components in the TFP product. In some other embodiments, fava bean protein components deliver 50 wt %, while plant protein components derived from a plant source other than fava bean deliver 50 wt % of the protein components in the TFP product. In some further embodiments, fava bean protein components deliver 55 wt %, while plant protein components derived from a plant source other than fava bean deliver 45 wt % of the protein components in the TFP product. In some still further embodiments, fava bean protein components deliver 60 wt %, while plant protein components derived from a plant source other than fava bean deliver 40 wt % of the protein components in the TFP product. In some still further embodiments, fava bean protein components deliver 65 wt %, while plant protein components derived from a plant source other than fava bean constitute 35 wt % of the protein components in the TFP product. In some still further embodiments, fava bean protein components deliver 70 wt %, while plant protein components derived from a plant source other than fava bean deliver 30 wt % of the protein components in the TFP product. In some still further embodiments, fava bean protein components deliver 75 wt %, while plant protein components derived from a plant source other than fava bean deliver 25 wt % of the protein components in the TFP product. In some still further embodiments, fava bean protein components deliver 80 wt %, while plant protein components derived from a plant source other than fava bean deliver 20 wt % of the protein components in the TFP product. In some still further embodiments, fava bean protein components deliver 85 wt %, while plant protein components derived from a plant source other than fava bean deliver 25 wt % of the protein components in the TFP product.

Accordingly, in some embodiments, the weight percentage ratio of the faba bean protein component to the non-fava bean protein component in the product may vary from about 0.8 to about 5.7. In some embodiments, said ratio may be, for example, from about 0.8, about 1, about 1.2, about 1.5, about 1.9, about 2.3, about 3, or about 4 up to about 1, about 1.2, about 1.5, about 1.9, about 2.3, about 3, about 4 or about 5.7.

In some embodiments, such as in those that employ fava bean protein concentrates and pea protein isolates, fava bean protein content may be, for example, from about 37 wt % to about 80 wt % calculated from the total protein content of the TFP product on dry basis. Likewise, pea protein content may be, for example, from about 20 wt % to about 63 wt % calculated from the total protein content of the TFP product on dry basis.

In some embodiments, such as in those that employ fava bean protein concentrates and pea protein isolates, the weight percentage ratio of fava bean protein content to the pea protein content in the product may vary, for example, from 0.58 to about 4.04. In some further embodiments, said ratio may be, for example, from about 0.58, about 0.71, about 0.87, about 1.07, about 1.33, about 1.6, about 2.14, or about 2.85 up to about 0.71, about 0.87, about 1.07, about 1.33, about 1.6, about 2.14, about 2.85 or about 4.04.

Those skilled in the art can readily choose appropriate plant protein components from the ones set forth above and combine them in a manner such that the total protein content of the final textured plant protein product is 56-80 wt % on dry matter basis, 45-85 wt % of the protein components being fava bean-derived and 15-55 wt % of the protein components being non-fava bean derived.

Plant-derived edible fibres were surprisingly found to be useful in the TFP product of the invention owing to their unexpected ability to prevent puffing. Consequently, air cavities, and glossy membraneous structures aligning them, formed during the manufacture of the product by a protein texturization extrusion process were lost, or at least significantly reduced both in size and number. These structural changes made the product a proper protein texturate with increased bulk density and enhanced meat-like bite and visible protein fibres. At the same time, functional properties of the TFP product were improved such that it absorbed water well without becoming too soft and losing its structural integrity upon rehydration.

Accordingly, the textured plant protein product of the invention comprises from 1 wt % up to 5 wt % of plant-derived edible fibres on dry basis. In some embodiments, the product may thus comprise from 1, 2, 3 or 4 wt % up to 2, 3, 4 or 5 wt % of plant-derived edible fibres. Preferably, the amount of such fibres in the product is 2-4 wt %, such as about 2, about 3 or about 4 wt % on dry basis.

As used herein, the term “plant-derived edible fibre” refers to a plant-based component rich in dietary fibres, i.e. non-starch polysaccharides that cannot be completely broken down by human digestive enzymes. Notably, such a component is separate from any plant-derived flour, protein concentrate and/or protein isolate employed in the present invention to provide proteins into the TFP product, although also they may contribute to the total dietary fibre content of the final product. Moreover, it is to be understood that any reference to plant fibres does not refer to the substantially aligned protein fibres in the TFP product of the invention.

Accordingly, the total dietary fibre content of the TFP product may be higher than the amount of edible plant-derived fibres provided by the edible plant-derived fibre component used in an amount ranging from 1 wt % up to 5 wt % calculated from the total dry matter content of the product. In some embodiments, the total dietary fibre content of the TFP product may be significantly higher than 1 wt %, such as significantly higher than 2 wt %, significantly higher than 3 wt %, significantly higher than 4 wt % or significantly higher than 5 wt % on dry basis.

In accordance with what is stated above, the terms “edible plant-derived fibre”, “plant-derived edible fibre”, “edible plant-derived fibre component” and “plant-derived edible fibre component” may be used interchangeably unless the context clearly dictates otherwise. Accordingly, the present invention provides a TFP product comprising from 1 wt % up to 5 wt % of an edible plant-derived fibre component on dry basis. In some embodiments, the product may thus comprise from 1, 2, 3 or 4 wt % up to 2, 3, 4 or 5 wt % of an edible plant-derived fibre component. Preferably, the amount of such a fibre component in the product is 2-4 wt %, such as about 2, about 3 or about 4 wt % on dry basis.

In some embodiments, the plant-derived edible fibre contains pectin.

Particularly good edible fibre-rich components, such as pectin-containing fibre components, to be included in the present TFP product are fibre concentrates, especially those that comprise both soluble and insoluble fibres, preferably in a weight ratio ranging from about 0.7 to about 1, a particularly beneficial weight ratio being about 0.84. Fibres with such solubility rates have the best effect in reducing the number and volume of air cavities in the final TFP product, thereby affecting its water absorption properties.

Edible fibre components with the desired solubility rate can be obtained from different plant sources by means and methods readily available in the art, often by drying and extracting juice, oils, and other non-fibrous compounds from the source material. Suitable sources for edible fibres include, but are not limited to, legumes such as fava beans, chickpeas, green peas, yellow peas, lentils, peanuts, trefoil, pinto beans, haricot beans, mung beans, navy beans, red beans, black beans, dark and light red kidney beans, green baby lima beans, pink beans, myasi beans, black eyed beans, cranberry beans, white beans, rice beans and butter beans; root crops such as carrots and beats; cereals such as rice, oats, maize, amaranth, barley, buckwheat, fonio, millet, wheat, rye, sorghum, triticale and quinoa; nuts such as pecans, hazelnuts, walnuts, Brazil nuts, cashews and almonds; seeds such as cottonseeds, flaxseeds, sunflower seeds and rapeseed; and tubers such as potatoes. In order to achieve a completely soy-free TFP product, edible fibres derived from soybeans are not to be used. Likewise, if a gluten-free TFP product is desired, the edible fibres are not to be derived from wheat, rye or barley. For a TFP product completely free from wheat gluten, no wheat-derived edible fibres can be used. In some embodiments, the TFP product does not contain any oat-derived components, including oat-derived edible fibres.

Fruit fibres are particularly preferred pectin-containing fibres to be included in the present TFP product, especially those with the desired solubility ratio set forth above. Non-limiting examples of suitable fruit fibres include citrus fibres, apple fibres, pineapple fibres and banana fibres. Common varieties of citrus fruits, and thus suitable sources of citrus fibres, include oranges, sweet oranges, clementines, kumquats, tangerines, tangelos, satsumas, mandarins, grapefruits, citrons, pomelos, lemons, rough lemons, limes and leech limes. Citrus fibres are typically obtained from citrus peel, citrus pulp, citrus rag or combinations thereof by means and methods well known in the art. Citrus fibres as well as fibre blends containing the same are also commercially available.

Optionally, the TFP product may also comprise saccharide syrup in an amount up to about 5 wt %, preferably in an amount from about 2 wt % to about 4 wt %. Preferred saccharide syrups include, but are not limited to, molasses, such as cane molasses, sugar beet molasses and fruit molasses, malt extracts such as barley malt extracts, and the like. Such edible saccharide syrups are generally available, or may be produced by means and methods well known in the art. The purpose of the saccharide syrup is to provide, for example, improved colour and a rounder taste. For the sake of simplicity, saccharide syrup is considered herein as a dry ingredient.

Those skilled in the art can readily choose appropriate plant protein components from the ones set forth above and combine them in a manner such that the total protein content of the final textured plant protein product is 56-80 wt % on dry matter basis, 45-85 wt % of the protein components being fava bean-derived and 15-55 wt % of the protein components being non-fava bean derived.

In accordance with the above, the TFP product may comprise from about 90 wt % to about 99 wt % of protein components, from about 1 wt % to about 5 wt % of edible plant-derived fibres and from none to about 5 wt % of saccharide syrup, with the proviso that the total sum does not exceed 100 wt %. The protein components consist from about 45 wt % to about 85 wt % of fava bean protein components and from about 15 wt % to about 65 wt % of one or more non-fava bean protein components. Some but not necessarily all suitable subranges within these limits are set forth above.

In some embodiments, the TFP product comprises from about 92 wt % to about 98 wt % of protein components, from about 2 wt % to about 4 wt % of edible plant-derived fibres and from 0 wt % to about 4 wt %, preferably from about 2 wt % to about 4 wt % of saccharide syrup, with the proviso that the total sum does not exceed 100 wt %. The protein components consist from about 45 wt % to about 85 wt % of a fava bean protein concentrate and from about 15 wt % to about 65 wt % of a pea isolate. Some but not necessarily all suitable subranges within these limits are set forth above.

In some preferred embodiments, the TFP product does not contain any ingredients derived from soybeans and/or wheat, i.e., can be denoted as soy-free and/or wheat-free, especially wheat gluten-free.

The moisture content of the TFP product may vary, but it is advantageously less than about 12%, preferably less than about 10% to extend the shelf-life of the product and avoid spoilage. In some embodiments, the moisture content of the TFP product is between about 8% and about 10%. Being a dry texturized plant protein product, the TFP needs to be hydrated prior to use. As already explained, the TFP product of the invention has excellent water absorption properties without becoming too soft and losing its structural integrity over time. These properties are very close to those targeted, i.e. those of the existing TVP products made from soy, and far better than those of the existing TVP products made from 100% of fava bean.

The TFP product may be formulated into any desired shape including, for example, granules, mince, flakes, files, chunks, poppers and cube-shaped pieces. Likewise, the selected shape can be provided in any desired size. In some non-limiting embodiments, the final TFP product is provided as granules or mince, preferably as granules or mince having an average particle size in the range of 1-15 mm, preferably in the range of 1-10 mm, more preferably in the range of 2-10 mm, 2-8 mm or 3-7 mm. In some other embodiments, the TFP product may have an average particle size in the range of 10-20 mm, 20-30 mm or 30-50 mm.

Bulk density of the final TFP product may also vary, typically being 100-500 g/l, preferably 200-400 g/l, more preferably around 300 g/l.

The TFP product of the invention is obtainable by low-moisture protein texturization extrusion, which process is one aspect of the present invention. Basically, there are two different types of extrusion processes for protein texturization in terms of usage of water. Low-moisture extrusion (also called dry extrusion) is an extrusion method wherein pre-combined dry ingredients are processed in the presence of limited amount of liquid water, usually below 40 wt %. The resulting products are dry and crunchy granules with a long storage-life. High-moisture extrusion (also called wet extrusion) differs from the low-moisture extrusion in the amount of water introduced during the extrusion process, ranging typically from 40-70 wt % in the mixture to be extruded. The resulting products are moist and truly meat-like products with realistic texture and organoleptic properties. The field of the present invention is that of the low-moisture protein texturization extrusion.

In the low-moisture extrusion process, the raw materials, i.e. protein components, edible plant-derived fibres, saccharide syrup (if present) and water, are fed into a closed extruder barrel system. The extruder barrel system contains one or more, preferably two, screws that mix and knead the raw materials into a hydrated dough and push the dough composition through successive zones of the barrel system. As the dough composition moves forward in the barrel system, increased heat and pressure convert the dough composition into a melted plasticized mass, while directional shear force causes alignment of the high molecular components in the mass, leading to the formation of substantially aligned protein fibres. The mass is then pushed through a die assembly whose configuration depends on the desired shape of the TFP extrudate. It is believed that also the die assembly contributes to the formation of the fibrous, meat-like structure by providing laminar flow and cooling to the resulting mixture. The die assembly may also be equipped with a cutter, for example a blade chopper, or a shredder to cut or shred the TFP extrudate into any desired size. After cutting or shredding, the TFP extrudate is usually dried.

In some embodiments, mixing of the dry ingredients, i.e. the protein components and the edible plant-derived fibres, with water is carried out in the extruder. The dry ingredients may be fed into the extruder separately or as a ready premixture. It is also possible to add water and mix it with the dry ingredients outside the extruder, although mixing water into the dry ingredients within the extruder is preferred. In some further embodiments, it is possible to add water to the dry ingredients or a premixture thereof in a pre-conditioner, for example in the form of steam or in a combination of liquid water and steam. In some embodiments, water may be introduced into the process by adding it both into the pre-conditioner and into the extruder. Typically, the amount of water used is such that the moisture content of the hydrated mixture during the extrusion process is below 40 wt %, sometimes below 30 wt %.

If saccharide syrup, such as molasses, is to be used, it may be added to water before the resulting mixture is introduced to the extruder or to the pre-conditioned, or it may be introduced thereto separately. Preferably, the syrup is fed into the extruder separately.

Water is added to the extrusion process typically in an amount of less than 40 wt-% of the total weight of the ingredients (i.e. the protein components, edible plant-derived fibres, saccharide syrup (if present) and water) to obtain a hydrated ingredient mixture. In some embodiments, water may be introduced into the extrusion process through a pre-conditioner, directly into the extruder or both. When introduced through the pre-conditioner, water may be provided as a combination of liquid water and steam.

In accordance with the above, the extruder may be any suitable extruder, such as a single screw extruder or a twin screw extruder, a twin screw extruder being preferred. Preferably, the extruder screws comprise various parts that have differing screw structure, to allow the hydrated mixture to be effectively formed into a dough. The parts may comprise parts that only convey the material forward (conveying parts), part that mix (mixing parts), other that knead (kneading parts), some may even force the mixture to go backwards (left-handed parts, which create pressure by forcing the material to go backwards). Moreover, the temperature within the various parts of the extruder may vary. A typical length of the extruder may be from 1.5 to 3 meters, such as about 2 meters. The rotation speed of the screw(s) may also vary on the length of the extruder. Typically, also the pressure inside the extruder is higher than the normal atmospheric pressure. It may be achieved either by separate input (increasing pressure) or it may be created by the functioning of the extruder and kneading of the hydrated mixture. Likewise, the temperature may be achieved by heating the extruder or it may be caused by the functioning of the extruder itself. Moreover, the mechanically induced movement of the extruded product also creates heat. Preferably, the temperature in the last barrel is below 170° C., more preferably below 165° C. Thus, the temperature may be, for example, from 130, 135, 140, 145, 150, 155, 160 or 165° C. up to 135, 140, 145, 150, 155, 160, 165 or 170° C.

At the end of the extruder, the dough composition is allowed to exit the extruder via a die assembly to form the TFP product. The die assembly may have any suitable form and length.

After extrusion, the TFP product may be cut into any desired size, using a knife arrangement, cutter or the like. In some embodiments, the TFP product is cut to a particle size of 1-15 mm on average. Thus, the particle size of the final TFP product may vary, for example, from 1, 2, 3, 4, 5, 6, 7, 8, 9, 10, 11, 12, 13 or 14 mm up to 2, 3, 4, 5, 6, 7, 8, 9, 10, 11, 12, 13, 14 or 15 mm on average. Preferred average particle sizes include, but are not limited to, those in the range of1-10 mm, 2-10 mm and 2-8 mm. Further preferred average particle sizes are in the range of 10-15 mm. These exemplary size ranges apply especially to embodiments, where the TFP is in the form of granules or mince.

In some other embodiments, the TFP product has an average particle size ranging from 10 mm to 20 mm, from 20 mm to 30 mm, or from 30 mm to 50 mm.

After cutting, the TFP product is preferably dried using any appropriate dryer, such as fluid belt dryer, to reduce the moisture content of the final TFP product to less than 12%, preferably to a moisture content between about 8% and about 10%. In some embodiments, the drying step also cools the product, preferably to ambient temperature.

Thereafter, the food product is typically packed.

In some embodiments, the TFP product may be subjected to further processing directly after cutting, i.e. without drying.

In some embodiments, the method of manufacturing the present TFP product in an extruder starts with providing dry ingredients comprising i) at least 90 wt % of protein components, of which 35-85 wt % are derived from fava beans and 15-65 wt % are derived from a source other than fava beans, soy or wheat, ii) and 1-5 wt % of edible plant-derived fibres, preferably fruit fibres such as citrus fibres. The dry ingredients are fed into a pre-conditioner along with water and steam, and mixed. The mixture is then passed into the extruder along with some more water to provide a hydrated ingredient mixture, the amount of water being up to 40 wt % of the total amount of the ingredient mixture and water. If up to 5 wt % of saccharide syrup, such as molasses, is to be used, it preferably fed into the extruder separately from the other ingredients. Next, the hydrated ingredient mixture is kneaded at a temperature of 130-170° C. in the extruder, to form a dough composition. The dough composition is then allowed to exit the extruder via a die assembly to form a TFP product with substantially aligned protein fibres. Preferably, the TFP product is then cut to have any desired size, such as to an average particle size of 1-15 mm (or to any other average particle size set forth above), to obtain the final TFP product. Preferably, the final TFP product is the dried to a moisture content below 12 wt %, preferably between about 8% and about 10%.

In some embodiments, the present TFP product is to be rehydrated prior consumption. Typically, the TFP product is to be used as a meat substitute, especially as a minced meat substitute, or as a protein source in vegetarian or vegan food products, or as a meat extender, especially as a minced meat extender, in meat products. Typical food products for such uses include, without limitation, meat balls and burgers, as well as products that imitate meat balls and burgers. TFP provides not only protein but also meat like texture into the food products.

Accordingly, an aspect of the invention relates to a food product made from or comprising the TFP product of the invention. Such food products include, but are not limited to, extended minced meat, extended meat balls, extended patties, extended burgers, minced meat imitations, meat ball imitations, patty imitations, burger imitations as well as different kinds of ready meals.

### Example 1. Manufacturing of Textured Fava Bean Protein Products

Different recipes were tested with an aim to prepare a textured vegetable protein product containing as much as fava bean protein as possible such that the product absorbs water well but retains its structural integrity after the absorption. Some test recipes are shown in Table 1 below. The amounts of ingredients are given as wt % on dry basis.

All test products were manufactured using a Bühler twin-screw 7-barrel extrusion system equipped with a pre-conditioner and a cutting head, and followed by a fluid belt dryer.

All protein components and fibre components (if present) were fed into the preconditioner and mixed with water. The hydrated mixture was then passed into the first barrel. More water was fed into the first barrel. Molasses were fed into the first barrel separately. The temperature profile was adjusted such that the temperature was the highest, around 165° C., in the last barrel. The cutting speed was set such that the particle size varied between 3 and 7 mm. After cutting, the extruded products were dried to a moisture content below 10 wt %.

TABLE 1
Exemplary recipes

| | Fava bean | | | | Observations | Observations |
|---|---|---|---|---|---|---|
| Recipe | protein | Pea protein | Citrus fibre | | on extruded | after |
| # | component* | component** | component*** | Molasses | ribbon | rehydration |
| 1 | 100 | | | | Extremely | Gets |
| | | | | | weak fibrous | extremely |
| | | | | | structure. | soft quickly |
| | | | | | Ribbon with | in hydration. |
| | | | | | large air | Gets mushy |
| | | | | | cavities, hard | and |
| | | | | | glossy | dissolves. No |
| | | | | | membraneous | bite |
| | | | | | structures | resistance. |
| | | | | | aligning the air | No water |
| | | | | | cavities | holding |
| | | | | | | capacity |
| 2 | 90 | 10 | | | Weak fibrous | Gets very |
| | | | | | structure. Air | soft in |
| | | | | | cavities | hydration. |
| | | | | | present. | Weak bite |
| | | | | | | resistance. |
| 3 | 80 | 20 | | | Bit weak | Quite weak |
| | | | | | fibrous | structure. |
| | | | | | structure. Air | Not strong |
| | | | | | cavities | bite |
| | | | | | present. | resistance. |
| 4 | 78 | 20 | 2 | | Firm ribbon | Good |
| | | | | | without air | structure. |
| | | | | | cavities; | Good bite |
| | | | | | fibrous | resistance. |
| | | | | | structure; | Good water |
| | | | | | increased bulk | holding |
| | | | | | density | capacity. |
| 5 | 76 | 20 | 2 | 2 | Firm and | Good and |
| | | | | | fibrous ribbon | firm |
| | | | | | without air | structure. |
| | | | | | cavities; | Good bite |
| | | | | | increased bulk | resistance. |
| | | | | | density | Good water |
| | | | | | | holding |
| | | | | | | capacity. |

*Fava bean protein concentrate (protein content 60%)
**Pea protein isolate (protein content 84%)
***soluble fibres 34.7%, insoluble fibres 41.4%

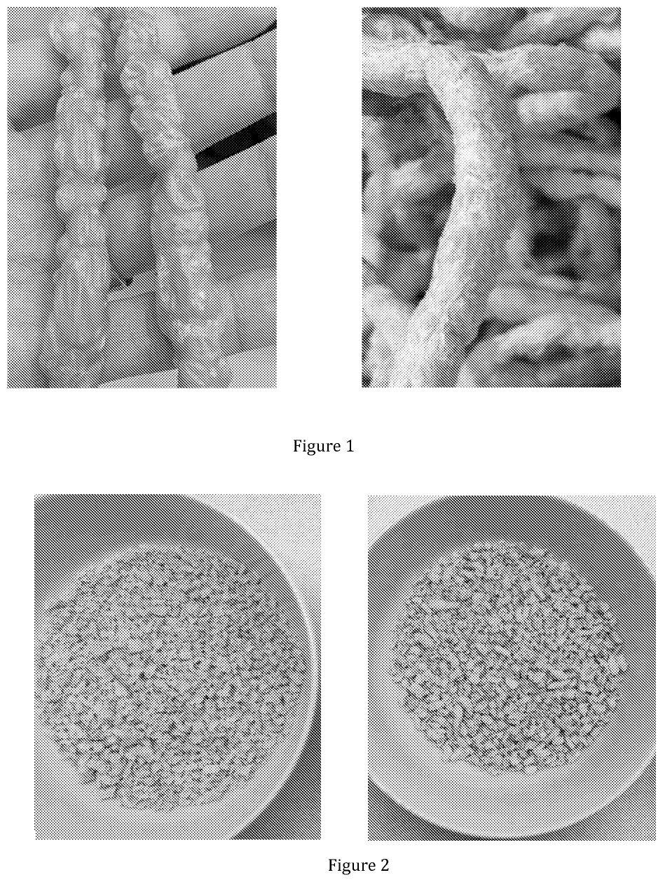

In view of the aim to have as much fava bean protein in the TFP product as possible, the first test recipe consisted of a fava bean concentrate only (comparative Recipe 1). The product obtained had too weak a fibrous structure with large air cavities. In order to improve protein texturization, pea protein was added into to the recipes, first in an amount of 10 wt % (comparative Recipe 2) and then 20 wt % (comparative Recipe 3; FIG. 1, on the left). Including pea protein in the recipe improved protein texturization concentration dependently, but the products still contained air cavities and did not have strong enough bite resistance.

It was unexpectedly found that including edible plant-derived fibres, such as citrus fibres, in the recipes caused the amount and size of air cavities in the extruded ribbon be markedly reduced. Consequently, also the hard and glossy membraneous structures aligning the air cavities were lost. These effects are demonstrated with TFP Recipes 4 and 5 of the invention in Table 1 above. A photograph of the TFP ribbon of Recipe 4 is shown in FIG. 1, on the right.

These important structural changes together had a favourable impact on the product's structural integrity after rehydration as well as on cooking resistance, as shown in Examples 2 and 3 below, respectively. Overall, the products of the invention had a look and feel very close to those of conventional TVP made from soy, as was aimed at. FIG. 2 shows photographs of a commercially available texturized soy protein and the TFP product according to Recipe 5.

Since the aim of this example was, without limitation, to include as much as fava bean protein in the TFP product as possible, recipes that contained fava bean components near the upper end of the disclosed range are disclosed, However, corresponding results can be obtained with other recipes within the limits disclosed herein.

### Example 2. Water Absorption Test and Sensory Evaluation

This experiment was carried out in order to compare water absorption properties of the TFP product manufactured in accordance with Example 1 to a commercially available textured fava bean protein product containing no protein source other than fava bean and to a commercially available textured soy protein product. All products were dry products.

To this end, 100 g of water (37° C.) was added on top of 10 g of each of the textured protein products in a beaker and mixed with gentle stirring using a spoon. After soaking for 5 min at room temperature, hydrated protein products were separated from non-absorbed water with a sieve, and both fractions were weighed twice to ensure correct measurement values. No pressure was applied to the hydrated products. The weight sum of the hydrated products and non-absorbed water was not exactly 110 g, indicating that a minor amount of water was retained in the sieves. However, this was not considered to compromise the accuracy of the test results.

All three hydrated protein products were subjected to sensory evaluation right after the sieving as well as after 20 min. The results are shown in Table 2 below.

TABLE 2
Results of water absorption test and sensory evaluation

| | | Commercially | Commercially |
|---|---|---|---|
| | | available | available |
| | TFP | textured fava bean | textured soy |
| Test product | (Recipe 5) | protein product | protein product |
| Protein content wt % | 63 | 65 | 53 |
| Particle size and shape, | Unevenly shaped | Unevenly shaped | Unevenly shaped |
| taste | mince, particle size | pieces, particle size | mince, particle size |
| | 3-7 mm; light gold | 1-1.5 cm; light beige | 2-5 mm; dark brown |
| | brown colour; mild | colour; bitter and | colour; grainy and a |
| | taste, toasted | typical taste of pulse | bit sweet taste, typical |
| | “mushroom” type | proteins | taste of soy |
| | taste | | |
| Bulk density g/l | 270 | 250 | 400 |
| Non-absorbed water g | 69 | 70 | 70 |
| Hydrated test product g | 38 | 36 | 39 |
| Sensory evaluation after | 4 | 2.5 | 5 |
| 5 min, scale 1-5 | | | |
| Sensory evaluation after | 4 | 2.5 | 5 |
| 20 min, scale 1-5 | | | |

Scale:
1 = extremely soft, no structure, no fibrous structure, no bite resistance
2 = soft, soft structure, weak bite resistance
3 = rather firm structure, some fibrous structure identified, a bit weak bite resistance
4 = quite firm structure, good bite resistance, fibrous structure
5 = firm structure, strong bite resistance, strong fibrous structure

Sensory properties of the present TFP product were acceptably close to those of the textured soy protein product. Thus, an aim of the invention, namely development of a textured protein product resembling commercially available textured soy protein products without using any soy was achieved. Moreover, the TFP product of the invention was clearly different from the commercially available textured fava bean protein product used in the test in its firmness after soaking in water. The commercially available textured fava bean product was very soft after soaking making its use in various food applications challenging. For example, when used as a meat replacement in vegetarian or vegan food products, such as meat ball or burger imitations, it is important that the textured protein product not only provides protein into the product, but also gives sufficient bite resistance and meat-like texture to the food product. If the firmness and structural integrity of the textured protein product is lost after rehydration, no proper meat imitation properties are achieved. The present TFP product overcomes this problem.

### Example 3. Cooking Resistance Test

This experiment was carried out in order to compare cooking properties of the TFP product manufactured in accordance with Example 1 to the commercially available products used in Example 2.

To this end, 50 g of each of the textured protein products and 100 g of water were mixed on a pan, and cooked for 3 min after reaching the boiling temperature with gentle stirring. Firmness of the products was evaluated after cooling. The results are shown in Table 3 below.

TABLE 3
Results of cooking resistance test

| | | Commercially | Commercially |
|---|---|---|---|
| | | available | available |
| | TFP | textured fava bean | textured soy |
| Test product | (Recipe 5) | protein product | protein product |
| Sensory evaluation | 3 | 1 | 4 |
| after cooking, | | | |
| scale 1-5 | | | |
| (1 = soft, | | | |
| 5 = firm) | | | |

The TFP product of the invention was in its cooking resistance closer to the target product, i.e. textured soy protein product, than the commercially available textured fava bean product was. The difference was even more evident than in the water absorption test.

1. A textured fava bean protein product, wherein the product has a total protein content of 56-80 wt % on dry matter basis and a dry matter content of at least 88 wt % of the total weight of the product, wherein the dry matter comprises:
90-99 wt % of plant protein components, 45-85 wt % of which are derived from fava bean and 15-55 wt % of which are derived from a plant source other than fava bean, soybean or wheat; and 1-5 wt % of an edible plant-derived fibre component.

2. The textured fava bean protein product according to claim 1, wherein the protein components derived from fava bean are provided in a form of a fava bean flour, a fava bean protein concentrate, a fava bean protein isolate or any mixture thereof.

3. The textured fava bean protein product according to claim 1, wherein the protein components derived from a plant source other than fava bean, soybean or wheat are not derived from oat or rapeseed.

4. The textured fava bean protein product according to claim 1, wherein the protein components derived from a plant source other than fava bean, soybean or wheat are derived from pea.

5. The textured fava bean protein product according to claim 4, wherein the protein components derived from pea and provided in a form of a pea protein concentrate, a pea protein isolate or any mixture thereof.

6. The textured fava bean protein product according to claim 1, wherein the edible plant-derived fibres are selected from the group consisting of fruit fibres, citrus fibres, legume fibres, root crop fibres, cereal fibres, nut fibres, seed fibres, tuber fibres and any mixtures thereof.

7. The textured fava bean protein product according to claim 1, wherein the edible plant-derived fibres are pectin-containing plant-derived fibres.

8. The textured fava bean protein product according to claim 6, wherein the edible plant-derived fibres comprise both soluble and insoluble fibres, in a weight ratio from 0.7 to 1.

9. The textured fava bean protein product according to claim 1, whose dry matter further comprises 1-5 wt % of saccharide syrup.

10. The textured fava bean protein product according to claim 1, wherein 65-85 wt % of the plant protein components are derived from fava bean and 15-35 wt % of the plant protein components are derived from a plant source other than fava bean, soybean or wheat.

11. The textured fava bean protein product according to claim 10, wherein the plant protein component derived from fava bean is a protein concentrate and the plant protein component derived from a plant source other than favea bean, soybean or wheat is a pea protein isolate.

12. The textured fava bean protein product according to claim 1, wherein the product does not contain any animal-derived ingredients.

13. A method of manufacturing a textured fava bean protein product by a low-moisture protein texturization extrusion, the method comprising:
providing ingredients comprising i) at least 90% by dry weight of protein components, of which protein components 45-85% by dry weight are derived from fava beans and 15-55% by dry weight are derived from a source other than fava beans, soy or wheat, ii) and 1-5% by dry weight of edible plant-derived fibres;
mixing the ingredients with water to provide a hydrated ingredient mixture, the amount of water being up to 40% by weight of the total weight of the hydrated ingredient mixture;
kneading the hydrated ingredient mixture at a temperature lower than 170° C. in an extruder, to form a dough composition;
passing the dough composition through a die assembly to form a textured fava bean protein product with substantially aligned protein fibres;
cutting the textured fava bean product with substantially aligned protein fibres; and
optionally, drying the product to a moisture content of less than 12 wt % of the total weight of the product.

14. The method according to claim 13, wherein the mixing is carried out in a pre-conditioner, in the extruder, or before feeding the mixture into the pre-conditioner or into the extruder.

15. The method according to claim 13, wherein the textured fava bean protein product with substantially aligned protein fibres is cut to have an average particle size in the range of 1-15 mm, 10-20 mm, 20-30 mm or 30-50 mm.

16. The method according to claim 13, wherein the final textured fava bean protein product has a feature set forth in claim 1.

17. A textured fava bean protein product obtainable by the method according to claim 13.

18. A food product comprising the textured fava bean protein product according to claim 1.

19. The textured fava bean protein product according to claim 9, where the saccharide syrup is molasses or malt extract.
